(19) United States
(12) Patent Application Publication
(10) Pub. No.: US 2021/0070602 A1
(43) Pub. Date: Mar. 11, 2021

(54) RAPID EFFERVESCENT BEVERAGE TAP

(71) Applicants: THOMAS WEISS, GAINSEVILLE, GA (US); MORGAN M. WEISS, GAINSEVILLE, GA (US)

(72) Inventors: THOMAS WEISS, GAINSEVILLE, GA (US); MORGAN M. WEISS, GAINSEVILLE, GA (US)

(21) Appl. No.: 17/008,970

(22) Filed: Sep. 1, 2020

Related U.S. Application Data
(60) Provisional application No. 62/897,089, filed on Sep. 6, 2019.

(51) Int. Cl. B67D 1/14

(52) U.S. Cl. CPC B67D 1/1433

(57) ABSTRACT

A rapid effervescent beverage tap produces a downward and tangential flowing beverage along the inside surface of the beverage container and therefore, very little froth. The rapid effervescent beverage tap enables beverage containers to be filled quickly, thereby increasing sales and reducing wait time for the froth to dissipate. The rapid effervescent beverage tap has a downward extension and a coupling portion extending therefrom having a radial angle and radial extension. The rapid effervescent beverage tap comprises a tangent bend in the outlet portion the bends the tangent extension circumferentially from the radial extension. This tangent extension terminates in the outlet opening. The outlet opening in the rapid effervescent beverage tap produces tangential and downward flow of beverage along the inside surface of a beverage container. The beverage swirls or spirals along the inside surface to the bottom of the container and very little froth or head is produced.

### BACKGROUND OF THE INVENTION

### Field of the Invention

The invention relates to a rapid effervescent beverage tap that produces a downward and tangential flowing beverage along the inside surface of the beverage container and very little froth.

### Background

Filling a beverage container, or glass, with an effervescent beverage, such as beer or soda, can be time consuming as the froth or head on the beverage prevents quick fluid filing. The beverage container may be filled incrementally with wait periods between filling to allow the head to dissipate. This takes a lot of time and in places where rapid filling is essential, such as a bars or sports arenas and stadiums, these delays can cost a lot money. Optionally, the froth can be allowed to spill over the top of the beverage container, which wastes the beverage and increases costs. Most traditional taps dispense the beverage downward or directly into the side of the beverage container and this abrupt shock and impact to the beverages causes dissolved gas to come out of solution and form froth. Some beverage taps are configured to fill a special type of beverage container from the bottom, but this requires a specialty container that is costly. Other beverage taps extend further down into the beverage container but they still produce a high impact flow of beverage against the container and therefore require waiting for froth to dissipate or allowing it to spill over.

### SUMMARY OF THE INVENTION

The invention is directed to a rapid effervescent beverage tap that produces a downward and tangential flowing beverage along the inside surface of the beverage container and therefore, very little froth. The rapid effervescent beverage tap enables beverage containers to be filled quickly, thereby increasing sales and reducing wait time for the froth to dissipate. An exemplary rapid effervescent beverage tap has a downward extension and a coupling portion extending therefrom having a radial angle and radial extension. An exemplary rapid effervescent beverage tap may further comprise a tangent bend in the outlet portion the bends the tangent extension circumferentially from the radial extension. This tangent extension terminates in the outlet opening. The tangent bent and tangent extension configure the outlet opening to be substantially tangential, or produce a flow of beverage that is substantially tangential with the inside surface of the beverage container when the end of the radial extension extends radially with respect to the center of the beverage container. The outlet opening in the rapid effervescent beverage tap produces tangential and downward flow of beverage along the inside surface of a beverage container. The beverage swirls or spirals along the inside surface to the bottom of the container and very little froth or head is produced.

In an exemplary embodiment, the rapid effervescent beverage tap comprises a bifurcated portion and two tap conduits that extend to separate outlet openings. Each of the outlet opening of the two tap conduits may comprise the radial bend and extension as well as the tangent bend and tangent extension. One or both of the outlet portions of a bifurcated rapid effervescent beverage tap may be rotatably connected to the downward extension of bifurcated portion to enable the outlet portion and outlet openings to be configured for various size or diameter beverage containers. The outlet openings of the bifurcated rapid effervescent beverage tap are configured produce concurrent flows of beverage along the inside surface of the beverage container. The two separate flows of beverage spiral around the inside of the beverage container in the same direction until they intercept with each other or collect in the bottom.

In an exemplary embodiment, a single beverage container is filled with a rapid effervescent beverage tap having a bifurcated portion and two outlet openings. The outlet openings may face opposing directions and produce concurrent flows of beverage along the interior surface of the beverage container. In another embodiment, two separate beverage containers are filled with an effervescent beverage from a bifurcated rapid effervescent beverage tap. The first outlet opening of a first outlet portion is configured in a first beverage container and a second outlet opening of a second outlet portion is configured in a second beverage container. Again, the outlet portion may be rotated to provide the proper configuration of the outlet opening for filling two beverage containers simultaneously.

The various portions and extensions of the rapid effervescent beverage tap may be detachably attachable for placement configuration and for easy cleaning.

The outlet opening and extension portion leading to the outlet opening may extend at a downward angle of no more than about 60 degrees or no more than about 45 degrees to reduce the impact of the beverage collection in the bottom of the container. If the angle is too great, the beverage may impact the bottom of the container too quickly and with too much speed and create froth. An exemplary tangent extension may extend a tangent angle from a radial axis or direction of at least 60 degrees or more, and preferably at least 5 degrees or more, or about 90 degrees or less and any range between and including the tangent angles provided.

A method of filing a beverage container with an effervescent beverage is provided using the rapid effervescent beverage tap as described herein. As described, a single beverage container may be filed with an exemplary rapid effervescent beverage tap having a single or two outlet openings. The outlet openings are configured proximal to the inside surface of the beverage container and the tap is opened to produce a tangent and downward flow of effervescent beverage along the inside surface of the beverage container. The beverage spirals around the inside surface to the bottom of the container and very little froth is produced.

An exemplary method of filing two beverage containers simultaneously may include providing a rapid effervescent beverage tap having a bifurcated portion and two separate outlet openings. The outlet portions may be rotated to configure the outlet openings proximal to inside surface of the two separate containers, with a first outlet opening proximal a first beverage container and a second outlet opening proximal the inside surface of a second beverage container. The tap may then be opened to produce a flow of effervescent beverage into the two separate containers, wherein each flow is downward and tangential with the inside surface of the respective beverage container.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a side view of an exemplary effervescent beverage tap having a downward extension, a bifurcated portion and a first and second outlet portions detached from each other.

FIG. 2 shows a side view of an exemplary effervescent beverage tap having a downward extension, a bifurcated portion and a first and second outlet portions configured with outlet openings in opposing directions.

FIG. 3 shows a top view of an exemplary effervescent beverage tap configured in a beverage glass and dispensing an effervescent beverage in a concurrent direction from the two opposing outlet openings.

FIG. 4 shows a side view of an exemplary effervescent beverage tap configured in a beverage glass and dispensing an effervescent beverage in a concurrent direction from the two opposing outlet openings.

FIG. 5 shows a side view of an exemplary effervescent beverage tap configured with a first outlet opening over a first beverage container and a second outlet opening over a second beverage container and dispensing an effervescent beverage into both at the same time.

FIG. 6 shows a side view of an exemplary effervescent beverage tap having a downward extension, a radial extension and a tangent extension that extends to an outlet opening.

FIG. 7 shows a side view of an exemplary effervescent beverage tap having a downward extension, a radial extension and a tangent extension that extends to an outlet opening that is dispensing an effervescent beverage tangentially along the inside surface of the beverage container.

FIG. 8 shows a top view of an exemplary effervescent beverage tap configured in a beverage glass and dispensing an effervescent beverage tangentially along the inside surface of the beverage container.

FIG. 9 shows a top view of an exemplary effervescent beverage tap configured in a beverage glass and dispensing an effervescent beverage tangentially along the inside surface of the beverage container.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

### Definitions

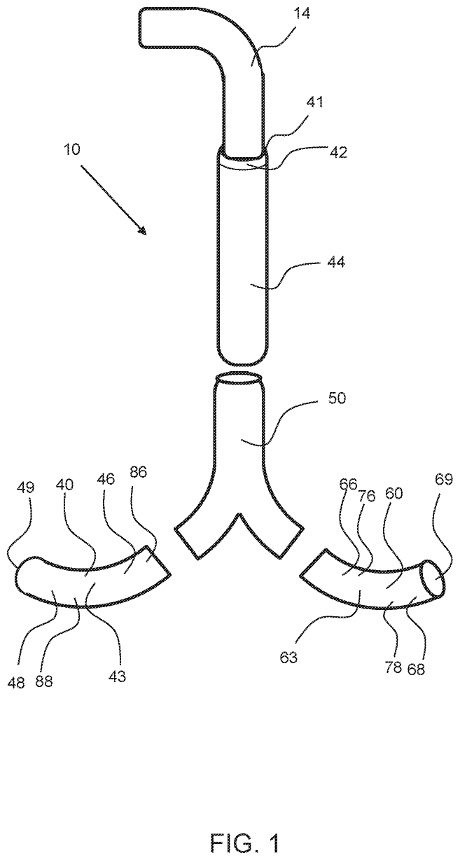

Referring now to FIGS. 1 to 5, an exemplary effervescent beverage tap 10 has a downward extension 44, a bifurcated portion 50, and two outlet portions 43 and 63 that are coupled to the bifurcated portion. The first and second outlet portion 43, 63, have a radial extension 46, 66 and tangent extension 48, 68 respectively. A coupling portion 42 is configured on a coupling end 41 and may be configured for attachment to a tap. The outlet openings 49, 69 of the outlet portions 43, 63 are configured to dispense an effervescent beverage in opposing and concurrent direction within a cylindrical beverage container, or glass, or into two separate glasses. The first radial extension 46 extends in an opposing direction to the second radial direction 66. The first tangent extension 48 extends in an opposing direction to the second tangent extension 68. An exemplary effervescent beverage tap 10 may be configured with portions that are detachably attachable to form said effervescent beverage tap 10 including a coupling portion 42 that forms part of the downward extension 44, a bifurcated portion 50 that bifurcates the coupling portion or downward extension into the first and second outlet portions 43, 63. The exemplary effervescent beverage tap 10 has a radial bend 86, 76 between the downward extension, that extends substantially downward, and the radial extensions that extend radially outward from the downward extension, to extend the outlets to the inside surface of a beverage container. The radial bend may be in the bifurcated portion 50 and/or in the outlet portion 43, 63, or may be gradual bend that is configured in both the bifurcated portion and the outlet portion. The first and second outlet portions also have a tangent bend 88, 78 that bends the outlet portion circumferentially to direct the outlet opening to dispense the beverage in a tangent direction with the inside surface of the beverage container, or glass. A first tap conduit 40 and second tap conduit 60 are formed by the components extending from the beverage tap 14, including the downward extension 44, the bifurcated portion 50 and the first and second outlet portions 43, 63, respectively.

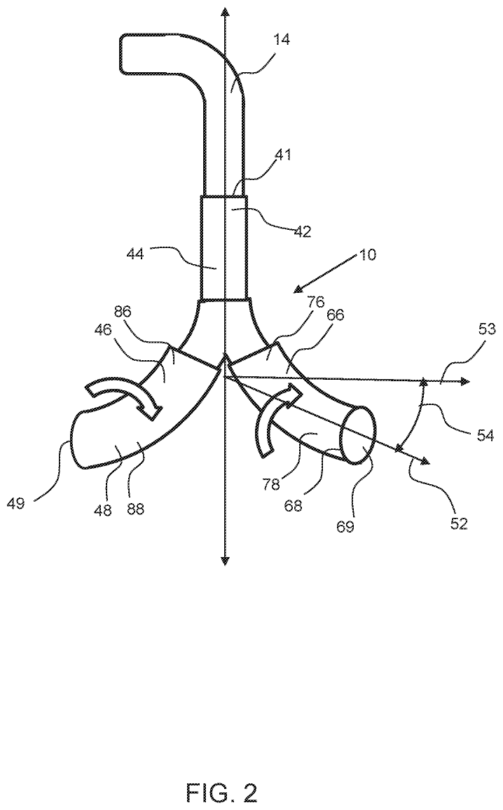

As shown in FIG. 2, the components of the exemplary effervescent beverage tap 10 shown in FIG. 1 are coupled together to form a first tap conduit 40 and second tap conduit 60. Note that the components may rotate, particularly the first and second outlet portions 43, 63, as indicated by the bold arrows to enable configuring the effervescent beverage tap for a particular sized beverage container or containers. As shown in FIG. 2, the pour axis 52, or the downward angle 54 from the horizontal axis 53 produces a downward flow of the beverage in the beverage container. The downward angle is preferably no more than about 75 degrees to prevent frothing of the beverage.

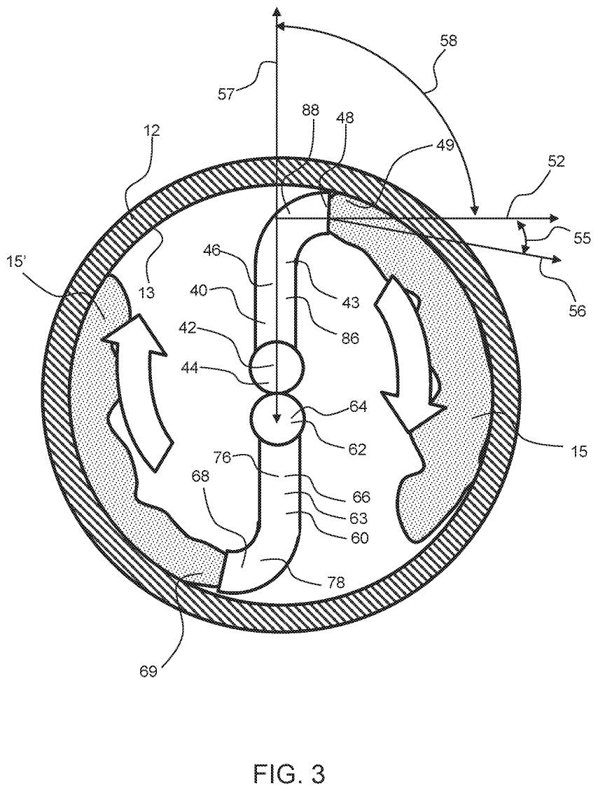

As shown in FIG. 3, the exemplary effervescent beverage tap 10 is dispensing an effervescent beverage 15 from the two outlet portions 43 and 63 into a single beverage container 12. The outlet opening 49 of the first outlet portion 43 is dispensing the effervescent beverage 15 in an opposing direction to the effervescent beverage 15′ being dispensed from the outlet opening 69 of the second outlet portion 63. This opposing dispensing direction creates a co-current flow, or spiraling flow of effervescent beverage within the container and this reduces frothing. Also shown are the tangent bends 88 and 78 in the first and second outlet portions that configure the outlet openings to dispense the beverage substantially tangentially with the inside surface 13 of the beverage container 12, or within about 50 degrees or less from the tangent axis 56 of the glass, as described herein. The tangent angle 58 is the total bend angle between the outlet opening pour axis 52 from the radial axis 57. As shown, there is an offset tangent angle 55 between the pout axis 52, the direction of pour of the beverage, and the tangent axis of the glass most proximal to the outlet opening. It is desirable to keep this offset tangent angle low, such as less than 45 degrees.

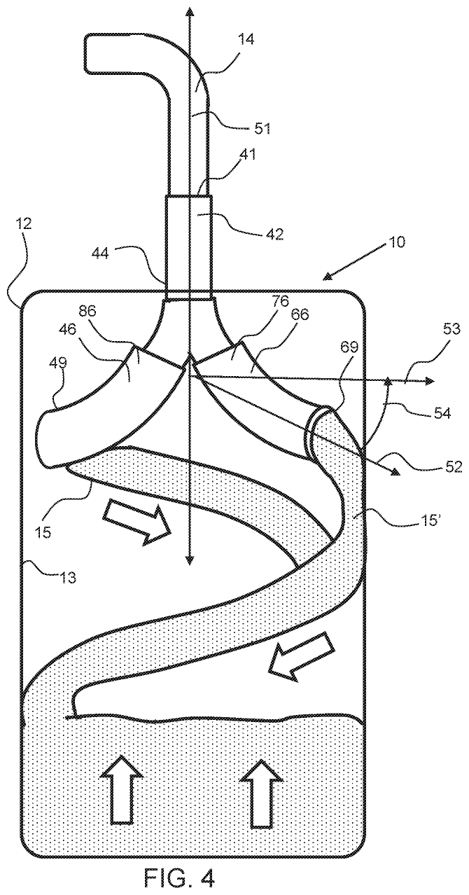

As shown in FIG. 4, the exemplary effervescent beverage tap 10 is configured in a beverage container 12 and dispensing an effervescent beverage 15, 15′ from the two opposing outlet opening 49, 69. The radial extensions 46, 66 of the first and second outlet portions extend in opposing directions, or substantially 180 degrees apart. The beverage is being dispensed in a downward angle 54 from the horizontal axis 53 to produce a co-current spiraling flow around the inside surface 13 of the beverage container 12. This configuration enables filling the beverage container with an effervescent beverage quickly with little froth or foam.

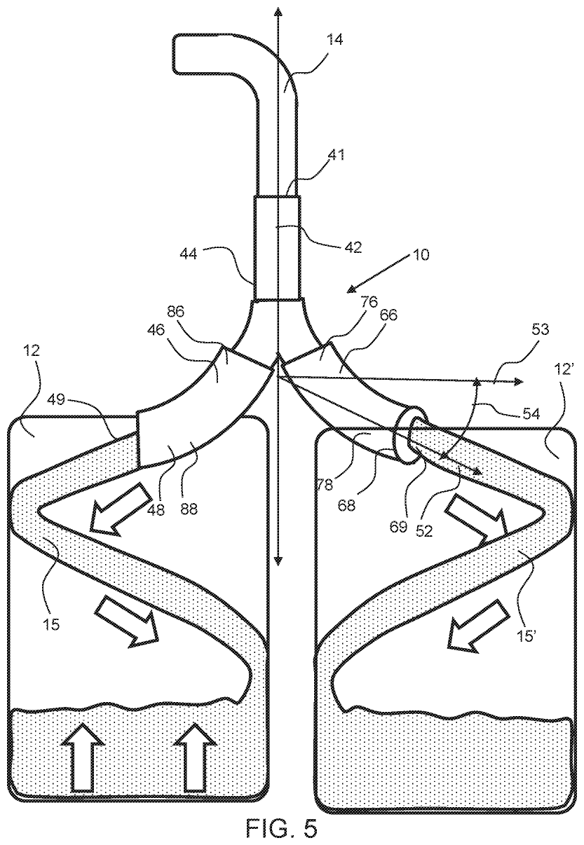

As shown in FIG. 5 the exemplary effervescent beverage tap 10 is configured to dispense effervescent beverage 15, 15′ into two beverage containers 12, 12′, respectively. The first outlet portion 43 extends into the first beverage container 12 and the second outlet portion 63 extends into the second beverage container 12′. The two outlet opening enable beverage to be dispensed into two containers at the same time. Note that the outlet openings may require rotating to configure the outlet openings as required to reduce froth.

As shown in FIG. 3, an exemplary effervescent beverage tap 10 has a downward extension 44, a radial extension 46 and a tangent extension 48 that extends to an outlet opening 49. The outlet opening extends at a downward angle 54 from a horizontal axis 53.

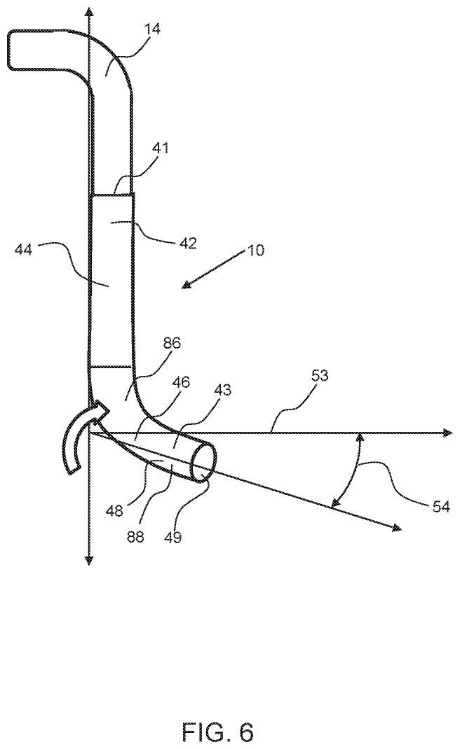

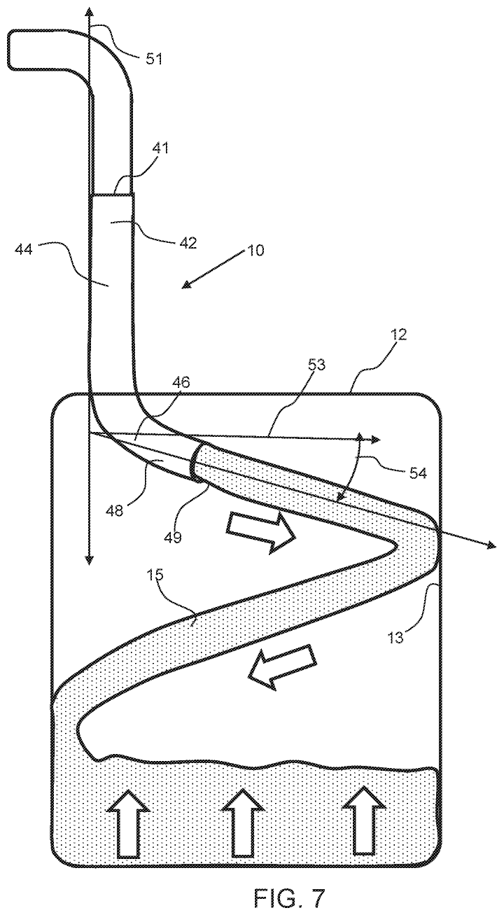

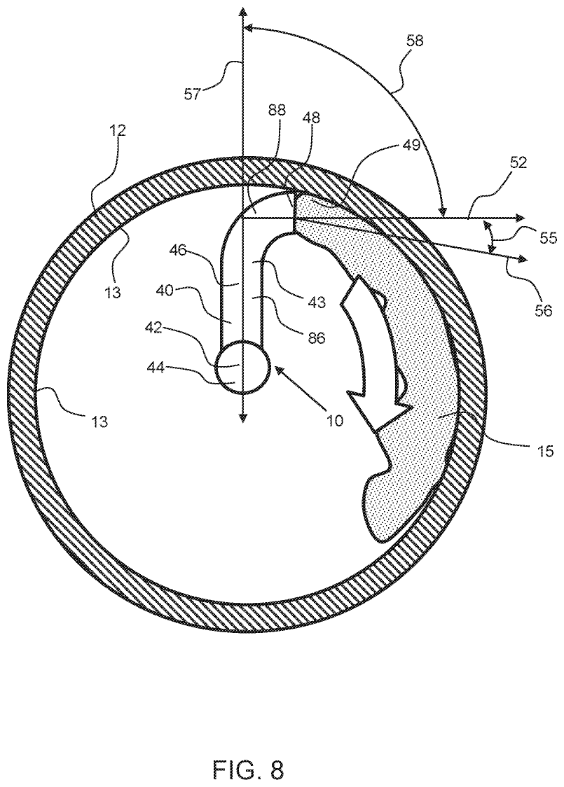

Referring now to FIG. 6 and FIG. 8, an exemplary effervescent beverage tap 10 is configured with a single outlet portion 43 coupled with the downward extension 44. The outlet portion has a radial bend 86 and tangent bend 88 to configure the outlet opening 49 for producing little froth when filling a beverage container. The pour axis 52 is configured at a downward angle 54 from the horizontal axis 53 as shown in FIG. 6 and FIG. 7. As shown in FIG. 7, the beverage 15 is dispensed into the beverage container 12 and swirls along the inside surface 13 to produce little froth. As shown in FIG. 8, the outlet portion 43 has a tangent bend 88 to configure the outlet opening 49 substantially tangentially with the inside surface 13 of the beverage container 12.

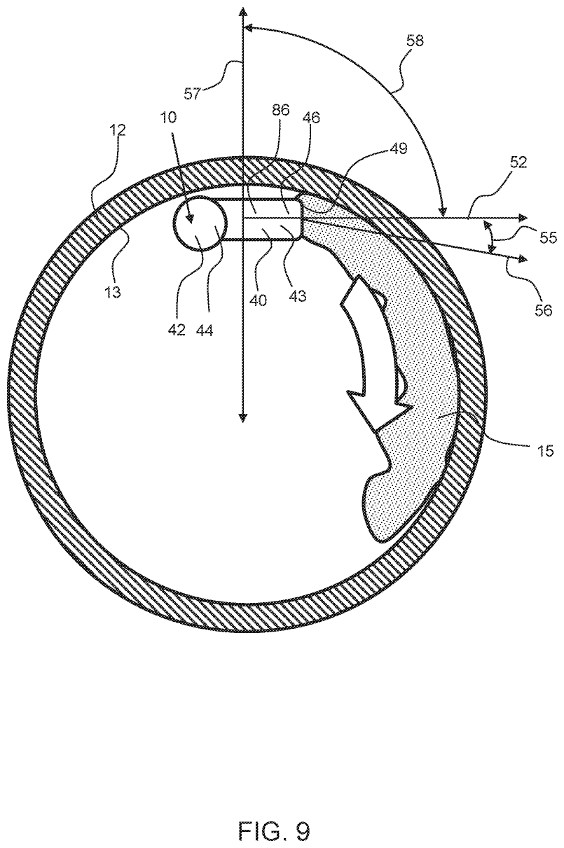

As shown in FIG. 9, an exemplary effervescent beverage tap 10 is configured with a single outlet portion 43 coupled with the downward extension 44. The outlet opening 49 is configured along an inside surface 13 of the beverage container 12 to dispense the effervescent beverage 15 tangentially along the inside surface or wall of the container. In this embodiment, the outlet portion 43 has a downward extension 44 and a radial extension 46 with a radial bend 86 between the radial extension and downward extension. The effervescent beverage tap 10 and configuration with respect to the beverage container is configured to produce little froth when filling a beverage container. The pour axis 52 is configured at a downward angle 54 from the horizontal axis 53 as shown in FIG. 6 and FIG. 7. As shown in FIG. 7, the beverage 15 is dispensed into the beverage container 12 and swirls along the inside surface 13 to produce little froth.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. An effervescent beverage tap comprising:
a) a first tap conduit comprising:
i) a downward extension;
ii) a first outlet opening;
iii) a first outlet portion comprising:
a first radial extension that extends radially outward along a first radial axis from the downward extension towards the first outlet opening,
a first tangent extension that extends a first tangent angle of at least 45 degrees from said first radial axis to direct the outlet opening circumferentially;
wherein the first tangent extension has a first downward angle of at least 10 degrees extending to the outlet opening and with respect from a horizontal axis.

2. The effervescent beverage tap of claim 1, further comprising:
a) a second tap conduit comprising:
i) a downward extension;
ii) a second outlet opening;
iii) a second outlet portion comprising:
a second radial extension that extends radially outward along a second radial axis from the downward extension toward the second outlet opening,
wherein the second radial extension extends in an opposing radial direction from the first radial extension;
iv) a second tangent extension that extends a second tangent angle of at least 45 degrees from said second radial axis to direct the outlet opening circumferentially;
wherein the second tangent extension has a second downward angle of at least 10 degrees extending to the second outlet opening and with respect from a horizontal axis
wherein the second tangent extension extends in an opposing direction to the first tangent extension;
wherein a beverage dispensed from the effervescent beverage tap is configured to be dispensed in a concurrent direction from the first tap conduit and the second tap conduit.

3. The effervescent beverage tap of claim 2, further comprising a bifurcated portion that is configured between the downward extension and the first outlet portion and the second outlet portions.

4. The effervescent beverage tap of claim 3, wherein the first outlet portion and second outlet portion are detachably attachable to the bifurcated portion.

5. The effervescent beverage tap of claim 3, wherein the first outlet portion and second outlet portion are rotatably connected to the bifurcated portion.

6. The effervescent beverage tap of claim 3, wherein the first downward angle and the second downward angle are each no more than 60 degrees from said horizontal axis.

7. The effervescent beverage tap of claim 3, wherein the first downward angle and the second downward angle are each no more than 45 degrees from said horizontal axis.

8. The effervescent beverage tap of claim 3, wherein the first tangent angle and second tangent angle are each at least 60 degrees from the first radial axis and second radial axis, respectively.

9. The effervescent beverage tap of claim 1, wherein the first downward angle is no more than 60 degrees from said horizontal axis.

10. The effervescent beverage tap of claim 1, wherein the first downward angle is no more than 45 degrees from said horizontal axis.

11. The effervescent beverage tap of claim 1, wherein the tangent angle is at least 60 degrees from the first radial axis.

12. A method of filing a beverage container with an effervescent beverage comprising:
a) providing an effervescent beverage tap comprising:
i) a first tap conduit comprising:
a downward extension;
a first outlet opening;
a first outlet portion comprising:
a first radial extension that extends radially outward along a first radial axis from the downward extension towards the first outlet opening,
b) configuring the outlet opening proximal to a inside surface of a beverage container;
c) opening the effervescent beverage tap to produce a flow of effervescent beverage from the first outlet opening that flows at a downward angle and tangentially along the inside surface of the beverage container to create a swirling flow of effervescent beverage around the inside surface of the beverage container that collects in the beverage container as a poured effervescent beverage;
whereby froth is minimized in the poured effervescent beverage.

13. The method of claim 12, wherein the outlet portion further comprises:
ii) a first tangent extension that extends a first tangent angle of at least 45 degrees from said first radial axis to direct the outlet opening circumferentially;
wherein the first tangent extension has a first downward angle of at least 10 degrees extending to the outlet opening and with respect from a horizontal axis.

14. The method of claim 13, wherein the effervescent beverage tap further comprises:
i) a second tap conduit comprising:
a downward extension;
a second outlet opening;
a second outlet portion comprising:
a second radial extension that extends radially outward along a second radial axis from the downward extension toward
the second outlet opening,
wherein the second radial extension extends in an opposing radial direction from the first radial extension;
ii) a second tangent extension that extends a second tangent angle of at least 45 degrees from said second radial axis to direct the outlet opening circumferentially;
wherein the second tangent extension has a second downward angle of at least 10 degrees extending to the second outlet opening and with respect from a horizontal axis
wherein the second tangent extension extends in an opposing direction to the first tangent extension;
wherein the second outlet opening is configured proximal to the inside surface of a beverage container when the first outlet opening is configured proximal to said inside surface of the beverage container;
b) whereby opening the effervescent beverage tap produces a flow of effervescent beverage from the second outlet opening that flows at a downward angle and tangentially along the inside surface of the beverage container to create a swirling flow of effervescent beverage around the inside surface of the beverage container that collects in the beverage container as a poured effervescent beverage;
wherein the flow of effervescent beverage from the first outlet opening and the second outlet opening are in concurrent direction.

15. The method of claim 14, further comprising a bifurcated portion that is configured between the downward extension and the first outlet portion and the second outlet portions.

16. The method of claim 15, wherein the first outlet portion and second outlet portion are detachably attachable to the bifurcated portion.

17. The method of claim 15, wherein the first outlet portion and second outlet portion are rotatably connected to the bifurcated portion.

18. The method of claim 15, wherein the first downward angle and the second downward angle are each no more than 60 degrees from said horizontal axis.

19. The method of claim 15, wherein the first downward angle and the second downward angle are each no more than 45 degrees from said horizontal axis.

20. The method of claim 15, wherein the first tangent angle and second tangent angle are each at least 60 degrees from the first radial axis and second radial axis, respectively.

21. The method of claim 15, further comprising:
a) rotating the first outlet portion about the downward extension to configure both the first outlet opening and second outlet opening proximal to the inside surface of the beverage container for dispensing said effervescent beverage.

22. The method of claim 15, further comprising:
a) rotating the first outlet portion about the downward extension and rotating the second outlet portion about the downward extension to configure both the first outlet opening and second outlet opening proximal to the inside surface of the beverage container for dispensing said effervescent beverage.
